(19) United States
(12) Patent Application Publication
(10) Pub. No.: US 2026/0146716 A1
(43) Pub. Date: May 28, 2026

(54) SECURING STRUCTURE FOR CONTAINER CLOSURE

(71) Applicant: AIRBUS OPERATIONS, S.L.U., Madrid (ES)

(72) Inventors: Alberto MOLINA PARGA, Madrid (ES); Jose Maria VEGUILLAS FUSTEL, Madrid (ES); Antonio Francisco PINTOR, Madrid (ES)

(21) Appl. No.: 19/403,655

(22) Filed: Nov. 28, 2025

(30) Foreign Application Priority Data
Nov. 28, 2024 (EP) 24383259

(51) Int. Cl. F17C 13/06

(52) U.S. Cl. CPC F17C 13/06; F17C 2205/0308; F17C 2205/0311

(57) ABSTRACT

A securing structure for container closure (401) that hinders a complete extraction of a container closure (401) from a container port (402) due to a deformation of the port (402) or the closure (401), the structure includes: an external ring (200) radially around an port (402); a retaining ring (300) within the external ring (200) and axially abutting an abutment surface (201) of the external ring (200), wherein the retaining ring includes: an external main body (301) and; an internal wedge element (302) tightly fitted in the external main body (301), and a retaining plate (100) axially covering the container port (402) in an axial direction of the container port (402), wherein the retaining plate (100) is attached to the external ring (200) by anchoring elements (101).

### RELATED APPLICATION

This application incorporates by reference and claims priority to European patent application EP 24383259.9, filed Nov. 28, 2024.

### TECHNICAL FIELD

The present invention is directed to a securing structure for container closure, wherein the securing structure is intended for hindering the accidental opening and/or collapse of the container due to an increase in pressure in the container.

This invention is applicable in the field of designing, manufacturing and operation of industrial facilities and/or vehicles such as aircrafts, comprising pressurized containers or tanks, in particular in hydrogen-powered aircrafts.

### BACKGROUND

In the context of hydrogen (H₂) powered aircraft development, large tanks of fuel need to be accommodated inside the aircraft.

Pressurized tanks, especially those in hydrogen aircraft, can experience significant pressure variations due to changes in ambient conditions such as temperature and pressure. These variations may be repeated in cycles, such as an aircraft repeatedly takes-off, climbs to a high altitude, e.g., above 30,000 feet, and returns to ground for landing. These cycles of variations in temperature and pressure can cause deformations in pressurized container and in closure systems on the container.

There could be a risk that deformations to a container and closure system could cause an accidental release of the closure system from the container. For example, a release may occur due to deformations in the geometry of the container or closure, such as minor deformations in the coupling threads used to attach the closures to the container. For example, threads on the closure system may deform and potentially could result in release of an unintended release of the closure system.

A sudden release of the container closure can cause that the container closure to be projected towards any surrounding object or person, thereby posing an important risk to the integrity of the facility within which said container is placed and/or to the physical integrity of the facility operators.

Furthermore, a sudden release of the container closure can cause that the pressurized gas inside the container to jet from the container. The jet of gas may harm nearby people and equipment. The gas jet may increase a risk of fire and explosion.

Pressurized containers, such as fuel tanks storing hydrogen fuel on an aircraft, experience significant pressure variations due to changes in ambient conditions, such as variations in ambient temperature and pressure. like temperature. These variations, or repeated pressurization cycles, can cause deformations in the container or the coupling threads of the closure.

### SUMMARY

A securing structure is disclosed herein to prevent accidental opening or collapse of closures, such as valves, nozzles and plugs, on pressurized containers. The containers may be pressurized fuel tanks on aircraft storing hydrogen (H₂) fuel to power hydrogen fuel engines providing thrust to the aircraft or other engines powering components in the aircraft.

With the aim of providing a solution to the abovementioned problems, the present invention refers to a securing structure for container closure. The securing structure for container closure, according to the present invention, is configured to hinder and/or impede a complete extraction of a container closure (such as a nozzle, a plug or valve) from a container port in the event of a deformation of the port and/or a deformation of the closure. This deformation may be caused by temperature variations that lead to pressure increases inside the container or tank. In particular it may be caused by deformations after multiple cycles of pressurization/depressurization of the container.

Moreover, to prevent the container closure from being unsafely released due to the increase of pressure in the tank, the securing structure of the present invention may be embodied to prevent projection of the container closure towards a nearby person or object. Preventing unsafe release increases the safety of pressurized containers, such as tanks.

The securing structure for container closure may include:
An external ring configured to be placed radially around an port of the container;
A retaining ring configured to be placed within the external ring and to be placed radially between the port of the container and the external ring, wherein the retaining ring comprises: an external main body and an internal wedge element configured to be tightly fitted into the external main body, the internal wedge element comprising an external conical surface faced towards a complementary internal conical surface of the external main body, wherein the retaining ring is configured such that, in use, the external conical surface of the internal wedge element is convergent towards the container, and
A retaining plate configured to axially cover the container port, wherein the retaining plate is configured to be attached to the external ring by means of anchoring elements.

Due To the securing structure for container closure described above, in cases where the closure could run out from the container port (e.g. due to a deformation of the container port), the closure is stopped by the retaining plate, thereby the closure being prevented from being projected against any surrounding object or person.

Moreover, in said cases of deformation, when the substance or fluid contained inside the container flows out from the container, said fluid is prevented from directly impacting any surrounding object or person, since the fluid jet would first collide against the retaining plate, thereby deviating its direct trajectory and losing energy.

According to a possible embodiment of the invention, the retaining ring is configured to axially abut against an abutment surface of the external ring. Alternatively, the retaining ring may be configured to be tightly fitted into the external ring.

The internal wedge element of the retaining ring may be configured to be tightly fitted into the external main body of the retaining ring.

According to a possible embodiment of the present invention, the retaining plate is configured to be placed in contact with the container closure.

According to another possible embodiment of the present invention, the retaining plate is configured to be placed such that there is a gap between the closure and the retaining plate, wherein said gap between the retaining plate and the closure is smaller than the axial dimension of the closure. Thus, in case of deformations provoking that the closure be displaced outwardly from the port, the small gap does not allow that the closure be completely extracted from the port of the container, while permitting a partial outward displacement of the closure allowing a controlled pressure decrease inside the container or tank. Thus, the pressure level inside the tank is controlled and is kept under a critical pressure level. The gas that has flown out from the container can be subsequently evacuated from the surrounding environment (e.g. by means of a ventilation or a gas extraction system).

According to a possible embodiment of the present invention, the external ring is configured to be placed within a support element of the container. The external ring may be arranged at a longitudinal end of the container (when the corresponding container port of the container is placed at such longitudinal end of the container). The support element allows the container to be stably supported on a supporting plate.

Furthermore, according to a possible embodiment of the present invention, the anchoring elements comprise anchoring bolts. Thus, a plurality of anchoring bolts allow to attach the retaining plate to the external ring, according to a longitudinal direction of the securing structure for container closure.

### SUMMARY OF DRAWINGS

As a means for better understanding at least one embodiment of the present invention, the following set of drawings is introduced by way of schematic illustration and in a non-limitative manner.

FIG. 1 is a schematic perspective exploded view of the securing structure for container closure, according to a possible embodiment of the present invention.

FIG. 2 is a schematic perspective section view of the securing structure for container closure of FIG. 1, in a mounted position.

FIG. 3 is a schematic planar section view of the securing structure for container closure of FIG. 2.

### DETAILED DESCRIPTION

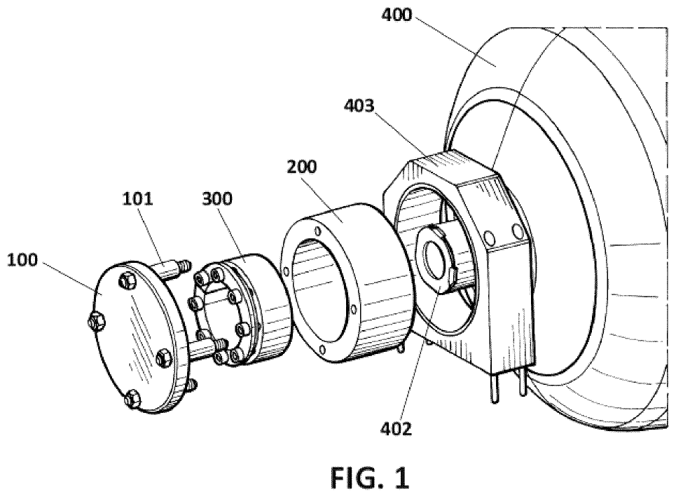

FIG. 1 schematically depicts an exploded perspective view of a possible embodiment of the securing structure (401) of the present invention.

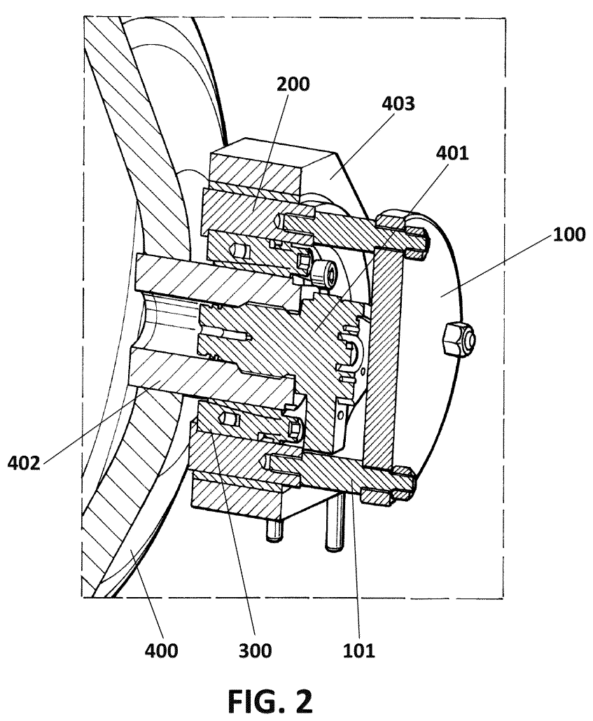

FIG. 2 schematically depicts a perspective section view of the securing structure of FIG. 1, mounted on a container port (402) wherein the securing structure (401), such as a valve, is placed at or in the container port (402). The securing structure may include a cylindrical threaded outer surface that engages with a cylindrical threaded inner surface of a collar of the container port.

As shown in FIG. 1 and FIG. 2, a container (400) or tank comprises a container port (402) for allowing the container (400) to be filled with a substance, such as a gas, and/or for allowing the substance to flow out from the interior of the container (400).

The container (400) comprises a support element (403) placed around the container port (402), for attaching or placing the container (400) upon a supporting plate (not shown). This support element (403) is configured to allow possible deformations of the container (400) due to variations in the pressure level of the substance inside the container (400).

The container (400) is configured to be closed or sealed by means of one or more closures (401), such as valves, nozzles or plugs, placed at one or more corresponding container ports (402) of the container (400).

The securing structure for the container closure (401) may include a retaining ring (300) configured to be placed around the container port (402) of the container (400).

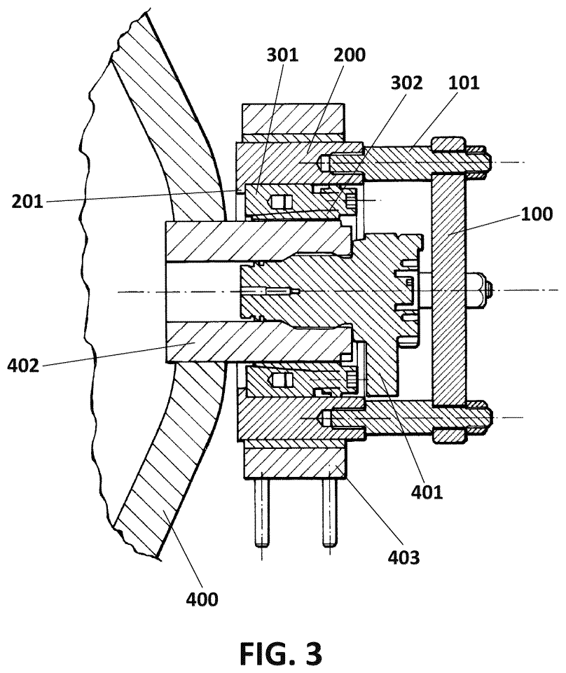

As more clearly shown in FIG. 3, the retaining ring (300) comprises an external main body (301) and an internal wedge element (302) with an external conical surface facing the external main body (301). The retaining ring (300) is configured such that the external conical surface of the internal wedge element (302) is convergent towards the container (400) body. The reason for such configuration is explained below.

The wedge element (302) is configured to be tightly fitted into the main body (301) of the retaining ring (300).

The retaining ring (300) is configured to be placed within an external ring (200).

According to the embodiment shown in the Figures, the external ring (200) is placed within the support element (403).

The external ring (200) comprises an abutment surface (201) configured to accommodate the retaining ring (300) and to, eventually, exert an axial pressure upon the retaining ring (300), as will be explained below.

The securing structure for container closure (401), object of the present invention, comprises a retaining plate (100) configured to axially cover the container port (402).

The retaining plate (100) is configured to be attached to the external ring (200) by means of anchoring elements (101) (such as bolts, rods or screws).

The retaining plate (100) is configured to axially cover the container port (402) of the container (400), i.e. to be disposed next to the container port (402) of the container (400), according to an axial direction thereof.

The retaining plate (100) may be disposed next to the port (402) of the container, such that there is a gap or space between the closure (401) (inserted or placed within the container port (402)) and the retaining plate (100). In this case, the gap or space between the retaining plate (100) and the closure (401) is smaller than the axial (or longitudinal) dimension of the closure (401) inserted in the container port (402).

In case there is an increase in the pressure level inside the container (400) that provokes a deformation of the container port (402) and/or a deformation of the closure (401) (e.g. a deformation of the thread) that leads to the closure (401) being axially displaced outwards from the container port (402), the retaining plate (100) impedes that the closure (401) completely runs out from the container port (402) and be projected towards surrounding objects or persons.

Moreover, as the axial displacement of the closure (401) is blocked by the retaining plate (100), the substance or fluid inside the container (400) is prevented from being directly jetted towards any surrounding person or equipment.

In the abovementioned cases, where the closure (401) is axially displaced towards the retaining plate (100), the axial force exerted by the closure (401) against the retaining plate (100) is transmitted by the anchoring elements (101) to the external ring (200), and further by the abutment surface (201) to the retaining ring (300), and more particularly, to the main body (301) of the retaining ring (300).

Furthermore, by means of the wedge element (302) of the retaining ring (300) (whose external conical surface is convergent towards the container (400)), any axial force transmitted to the main body of the retaining ring (300) is partially converted into a radial force exerted by the wedge element (302) against the container port (402) of the container (400), this radial force being transmitted to the closure (401).

Therefore, the higher is the axial pressure/force exerted by the closure (401) against the retaining plate (100), the higher is the radial force exerted against the container port (402) by the wedge element (302) of the retaining ring (300). Thus, a retaining effect is achieved by means of the securing structure of the present invention, this retaining effect hindering and/or impeding that the container closure (401) completely runs out and/or be completely extracted from the container port (402).

The invention may be embodied as a securing structure for container closure (401) configured to impede a complete extraction of a container closure (401) from a container port (402), wherein the securing structure for container closure (401) includes:
An external ring (200) configured to be placed radially around the container port (402) of the container (400), and
A retaining ring (300) configured to be placed within the external ring (200) and to be placed radially between the container port (402) of the container (400) and the external ring (200), wherein the retaining ring (300) comprises an external main body (301) and an internal wedge element (302) the internal wedge element (302) comprising an external conical surface faced towards a complementary internal conical surface of the external main body (301), wherein the retaining ring (300) is configured such that, in use, the external conical surface of the internal wedge element (302) is convergent towards the container (400); and a retaining plate (100) configured to axially cover the container port (402) in an axial direction of the container port (402), wherein the retaining plate (100) is configured to be attached to the external ring (200) by means of anchoring elements (101).

The retaining ring (300) may be configured to axially abut against an abutment surface (201) of the external ring (200).

The internal wedge element (302) of the retaining ring (300) may be configured to be tightly fitted into the external main body (301) of the retaining ring (300).

The retaining plate (100) may be configured to be placed in contact with the container closure (401).

The retaining plate (100) may be configured to be placed such that there is a gap between the closure (401) and the retaining plate (100), wherein said gap between the retaining plate (100) and the closure (401) is smaller than the axial dimension of the closure (401).

The external ring (200) may be configured to be placed within a support element (403) of the container (400).

The anchoring elements (101) may comprise anchoring bolts.

The invention may be embodied to provide a safety structure that hinders or impedes the complete extraction of a container closure (401) from the container outlet (402) during a failure event. If the closure (401) accidentally is displaced, it impacts a retaining plate (100) which prevents the closure from becoming a projectile. The retaining plate (100) deflects the trajectory of escaping fluid, causing it to lose energy rather than jetting directly at surroundings. The securing structure of the retaining plate, anchoring elements (101), external ring (200) and retaining ring (300) converts the outward axial force of the failing closure into a radial gripping force that tightens the structure against the container.

The securing structure is arranged around the outlet (402) of a container (400). The securing structure includes a retaining plate (100) that axially covers the container port and forms a physical barrier against ejection of the closure (401). The securing structure also includes anchoring elements (101), e.g., bolts, rods or screws, that attach the retaining plate (100) to the external ring (200) and transmitting forces applied to the retaining plate longitudinally along the anchoring elements to the external ring (200).

A ring assembly includes an external ring (200) and a retaining ring (300). The external ring (200) is placed radially around the container outlet. In some embodiments, the external ring fits within a support element (403) of the container. The external ring may include an annular abutment surface (201) that abuts an end of the retaining ring (300) and particularly the external main body (301) of the retaining ring.

The retaining ring (300) is between the container outlet (402) and the external ring (200) and may abut against the abutment surface (201) of the external ring (200).

The retaining ring includes a wedge mechanism that converts axial forces applied to retaining plate (100) to movement that secures the retaining ring to a collar of the container port (402). The retaining ring (300) includes an annular external main body (301) having a first frustoconical inner surface which faces a second frustoconical outer surface of an annular internal wedge element (302). The opposing first and second frustoconical surfaces form the wedge mechanism and allow the internal wedge element (302) to be tightly fitted within the external main body (301). The frustoconical surface of internal wedge element (302) is convergent towards the container body along a direction from a distal end of a collar for the container port (402) and towards container (400).

The retaining plate (100) is positioned over the closure (401). A narrow gap may be between the retaining plate and the closure and a post through the retaining plate may engage the closure. If there is a gap, the gap is narrower than the axial length of the closure to ensure the closure cannot fully eject from container port (4022) before being constrained by the retaining plate.

If the container closure (401) fails and unintentionally releases from the container port (402), the closure may move axially out of the container port and impact the retaining plate (100). Because any gap between the closure and retaining plate is less than the length of the closure, the closure hits the retaining plate before being fully out of the container port.

Any outward movement of the closure (401) partially from the container port (402) may allow for fluid in the container to leak from the container port. Because the closure remains partially in the container port, the leak is controlled and less rapid than if the closure would be entirely out of the container port.

Any force caused by the container closure (401) impacting the retaining plate (300) is transferred from the plate, to the anchoring elements (101), to the external ring (200) and to the retaining ring main body (301). The force applied to the retaining ring main body (301) may cause the main body to move slightly axially away from the container (400). This movement causes the frustoconical surface on the main body (301) to slide against the frustoconical surface of the internal wedge element (302). This movement causes the thickness to increase, in a radial direction, of the combined main body and internal wedge. The increased thickness causes the combined main body and internal wedge to apply radial forces outwardly against the external retaining ring (200) and inwardly against the collar of the container port (402). These radial forces cause the retaining ring (200) to further bind to the collar of the container outlet and resists the force of the container closure (401) to be dislodged from the container port.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise.

Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A securing structure for container closure configured to impede a complete extraction of a container closure from a container port, wherein the securing structure for container closure comprises:
an external ring configured to be placed radially around the container port;
a retaining ring configured to be placed within the external ring and to be placed radially between the container port and the external ring, wherein the retaining ring comprises:
an external main body, and
an internal wedge element the internal wedge element comprising an external conical surface faced towards a complementary internal conical surface of the external main body,
wherein the retaining ring is configured such that the external conical surface of the internal wedge element is convergent towards the container, and
a retaining plate configured to axially cover the container port in an axial direction of the container port,
wherein the retaining plate is configured to be attached to the external ring by anchoring elements.

2. The securing structure for container closure according to claim 1, wherein the retaining ring is configured to axially abut against an abutment surface of the external ring.

3. The securing structure for container closure according to claim 1, wherein the internal wedge element of the retaining ring is configured to be tightly fitted to the external main body of the retaining ring.

4. The securing structure for container closure according to claim 1, wherein the retaining plate is configured to be placed in contact with the container closure.

5. The securing structure for container closure according to claim 1, wherein the retaining plate is configured to be placed such that there is a gap between the container closure and the retaining plate which is shorter than a length of the container closure along an axis of the container port.

6. The securing structure for container closure according to claim 1, wherein the external ring is configured to be placed within a support element of the container.

7. The securing structure for container closure according to claim 1, wherein the anchoring elements include anchoring bolts.

8. A high pressure container assembly configured to hold a high pressure fluid, the container assembly including:
a container configured to hold the high pressure fluid;
a container port on the container and configured to allow the high pressure fluid to pass into or out of the container, wherein the container port includes a collar surrounding the port and extending outward from the container;
a securing structure configured to close the closure port and prevent leakage of the high pressure fluid from the container through the container port, wherein the securing structure is seated in the container port and engages an inner wall of the collar;
an external ring extending around the container port, wherein the external ring has an opening having a wider diameter than the outer diameter of the collar of the container port and the external ring includes an annular abutment surface
a retaining ring configured to be placed within the external ring and to be placed radially between the container port and the external ring, wherein the retaining ring comprises:
an annular external main body extending around the container port and including:
an outer cylindrical surface abutting an inner cylindrical surface of the external ring,
an annular inner frustoconical surface, and
an end abutting the annular abutment surface of the external ring, and
an annular internal wedge element including an annular inner surface extending around and abutting a cylindrical outer surface of the collar of the container port and an annular outer frustoconical surface in sliding contact with the annular inner frustoconical surface of the annular external main body, wherein the annular internal wedge element is sandwiched between the annular external main body and the collar of the container port, wherein a thickness of the annular internal wedge element reduces in a direction towards the container;
a retaining plate covering the securing structure in the container port and separated by a gap between a distal end of the securing structure and the retaining plate; and
anchoring elements securing the retaining plate to the external ring.

9. The high pressure container according to claim 8, wherein the high pressure container is configured to be mounted within an aircraft and the high pressure fluid in hydrogen (H₂).

10. The high pressure container according to claim 8, wherein the retaining ring is configured to axially abut against an abutment surface of the external ring.

11. The high pressure container according to claim 8, wherein the retaining plate is perpendicular to an axial axis of the container port and of the securing structure.

12. The high pressure container according to claim 8, further comprising a support element extending around and secured to the support ring, wherein in the support element is configured to support the high pressure container in another structure.

13. The high pressure container according to claim 8, wherein annular the annular external main body is configured to slide across the annular internal wedge in a direction towards the container when an axial force is applied to the annular external main body by the retaining plate.

14. The high pressure container according to claim 8, wherein the retaining plate includes a post configured to contact the container closure.

15. The high pressure container according to claim 8, wherein the gap between the container closure and the retaining plate is shorter than a length of the container closure along an axis of the container closure.
